(19) United States
(12) Patent Application Publication
(10) Pub. No.: US 2018/0142602 A1
(43) Pub. Date: May 24, 2018

(54) DUST EJECTOR AND EXHAUST TUBE ASSEMBLY

(71) Applicant: Caterpillar Global Mining Equipment LLC, Denison, TX (US)

(72) Inventors: Jerry E. BERKELAND, Melissa, TX (US); Qinyang RAO, Washington, IL (US)

(73) Assignee: Caterpillar Global Mining Equipment LLC, Denison, TX (US)

(21) Appl. No.: 15/358,882

(22) Filed: Nov. 22, 2016

(51) Int. Cl. F01N 13/08; F16L 9/19

(52) U.S. Cl. CPC F01N 13/08; F01N 2470/24; F16L 9/20

(57) ABSTRACT

A dust ejector and exhaust tube assembly is provided. The dust ejector and exhaust tube assembly comprises an exhaust tube, and a dust ejector tube at least partially located within the exhaust tube. The dust ejector tube includes a tube portion having a constant diameter smaller than a diameter of the exhaust tube. The dust ejector tube further includes an outlet portion including an outlet of the dust ejector tube. The outlet of the dust ejector tube has a diameter larger than the constant diameter of the tube portion.

### TECHNICAL FIELD

The present disclosure relates to dust ejectors, and more particularly to a dust ejector and exhaust tube assembly and a method of assembling the dust ejector and exhaust tube assembly.

### BACKGROUND

Certain machines, such as drilling machines, include multiple air-intake components, and a single component for allowing exhaust matter to flow out of the machine. For providing clean air to the air-intake components, a machine may also include one or more air pre-cleaners to remove dust particles from the air entering the air-intake components. For example, a drilling machine may include an engine and a compressor as the air-intake components, each requiring a separate air intake and an air pre-cleaner. Such air pre-cleaners may forward the dust particles removed from the air entering the engine or the compressor to a single dust ejector tube located within an exhaust tube of the engine. Therefore, in such machines, often a single dust ejector tube needs increased suction to eject large amounts of dust particles flowing from multiple air pre-cleaners.

Conventionally, increased suction at an outlet of the dust ejector tube may be achieved by increasing a diameter of the dust ejector tube. However, such an increase in the diameter of the dust ejector tube may increase a frictional resistance for exhaust gases while moving out of the machine resulting in a backpressure on the engine. The backpressure may lead to an additional parasitic load on the engine, and eventually to a poor performance of the engine. Therefore, a problem exists in the conventional technology because increasing suction at the outlet of the dust ejector tube causes backpressure on the engine.

European Patent No. 0536038 (hereinafter the '038 patent), shows a dust ejector tube with a conical portion. However, the conical portion does not include an outlet of the dust ejector tube. That is, the conical portion is connected to a portion with a constant diameter, which includes the outlet of the dust ejector tube. Therefore, the dust ejector tube of the '038 patent increases the diameter of the outlet portion of the dust ejection tube, which leads to a higher backpressure on the engine, as described above.

### SUMMARY OF THE DISCLOSURES

In one aspect of the present disclosure, a dust ejector and exhaust tube assembly is disclosed. The dust ejector and exhaust tube assembly includes an exhaust tube, and a dust ejector tube at least partially located within the exhaust tube. The dust ejector tube includes a tube portion disposed concentrically within the exhaust tube and having a constant diameter smaller than a diameter of the exhaust tube. The dust ejector tube further includes an outlet portion including an outlet of the dust ejector tube. The outlet of the dust ejector tube has a diameter larger than the constant diameter of the tube portion.

In another aspect of the present disclosure, a dust ejector and exhaust tube assembly is disclosed. The dust ejector and exhaust tube assembly comprises an exhaust tube having a wall opening, and a dust ejector tube at least partially located within the exhaust tube. The dust ejector tube includes an outside portion located outside the exhaust tube, a tube portion having a constant diameter smaller than a diameter of the exhaust tube, and an outlet portion connected to the tube portion and including an outlet of the dust ejector tube. The outlet of the dust ejector tube has a diameter that increases linearly from a point closest to the tube portion to the outlet. The tube portion is connected to the outside portion via the wall opening in the exhaust tube. An engine exhaust flows through the exhaust tube and around a portion of the dust ejector tube located within the exhaust tube. Further, dust particles flow through the outlet of the dust ejector tube into the exhaust tube.

In yet another aspect of the present disclosure, a method of assembling a dust ejector and exhaust tube assembly is disclosed. The method comprises partially disposing a dust ejector tube within an exhaust tube having a wall opening. An outside portion of the dust ejector tube is located outside the exhaust tube, and a tube portion of the dust ejector tube and an outlet portion of the dust ejector tube are located within the exhaust tube. The method further comprises disposing the tube portion of the dust ejector tube to be connected to the outside portion via the wall opening in the exhaust tube. The tube portion of the dust ejector tube has a constant diameter smaller than a diameter of the exhaust tube. The outlet portion of the dust ejector tube includes an outlet of the dust ejector tube. The outlet of the dust ejector tube has a diameter larger than a diameter of any other part of the outlet portion.

Other features and aspects of this disclosure will be apparent from the following description and the accompanying drawings.

### BRIEF DESCRIPTION OF THE DRAWINGS

The accompanying drawings, which are incorporated in and constitute a part of the specification, are illustrative of one or more embodiments and, together with the description, explain the embodiments. The accompanying drawings have not necessarily been drawn to scale. Further, any values or dimensions in the accompanying drawings are for illustration purposes only and may or may not represent actual or preferred values or dimensions. Where applicable, some or all select features may not be illustrated to assist in the description and understanding of underlying features.

FIG. 1 is a perspective view of a machine having a dust ejector and exhaust tube assembly, according to one or more embodiments of the present disclosure;

FIG. 2 is a cross-sectional view of the dust ejector and exhaust tube assembly, according to one or more embodiments of the present disclosure;

FIG. 3 is a cross-sectional view of the dust ejector and exhaust tube assembly depicting flow paths of engine exhaust and dust particles, according to one or more embodiments of the present disclosure;

FIG. 4 is a flowchart for a method of assembling the dust ejector and exhaust tube assembly, according to one or more embodiments of the present disclosure.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, well-known structures and components may be shown in block diagram form in order to avoid obscuring the concepts of the described subject matter. Wherever possible, corresponding or similar reference numbers will be used throughout the drawings to refer to the same or corresponding parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural references unless the context clearly dictates otherwise. That is, unless clearly specified otherwise, as used herein the words “a” and “an” and the like carry the meaning of “one or more.” Additionally, it is to be understood that terms such as “left,” “right,” “up,” “down,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Generally speaking, embodiments of the present disclosure provide a dust ejector and exhaust tube assembly including a dust ejector tube located within an exhaust tube. The dust ejector tube may have an outlet with a diverging conical shape. The diverging conical shape may increase suction at the outlet of the dust ejector tube while decreasing backpressure on the engine through the exhaust tube. The embodiments of the present disclosure can further provide the dust ejector tube and a method of manufacturing the dust ejector tube such that the suction at the outlet is increased in order to handle a large amount of dust particles flowing from pre-cleaners, and the backpressure associated with the exhaust tube is decreased.

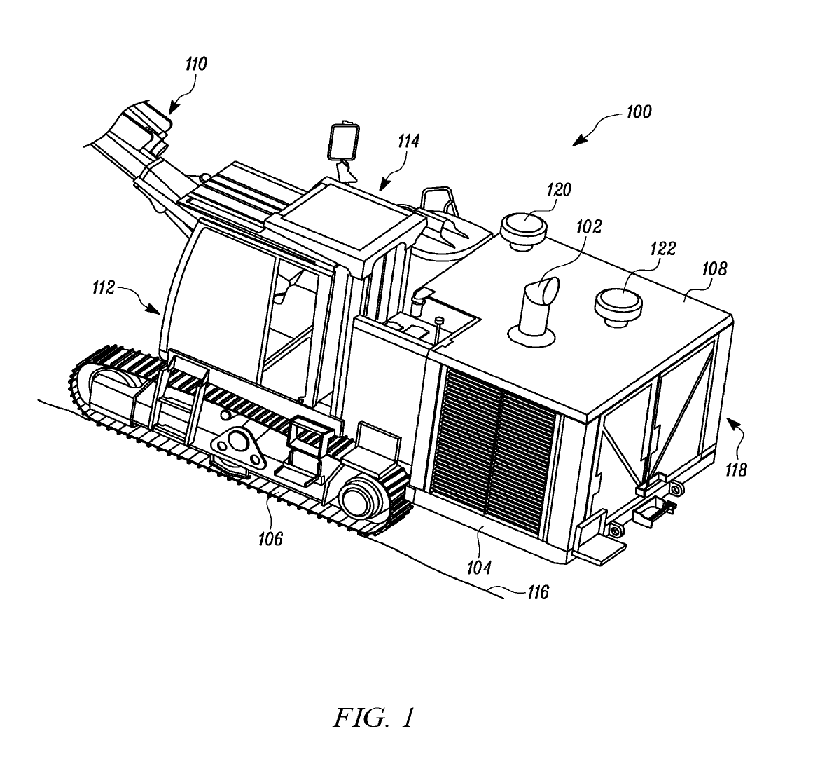

FIG. 1 is a perspective view of a machine 100 having a dust ejector and exhaust tube assembly 102, according to one or more embodiments of the present disclosure. In one embodiment, the machine 100 may be a drilling machine 100. Although, the present disclosure is explained with regard to the machine 100 being the drilling machine 100, the present disclosure is equally applicable to other machines having dust ejector and exhaust assemblies. In other embodiments, the machine 100 may be, but is not limited to, a back hoe loader, a wheel loader, a haul truck, a motor grader, an articulating truck, a bulldozer, an excavator, a scraper, a shovel, or other machines known in the art. More specifically, the machine 100 may be any machine 100 including one or more air-intake components and a component for allowing exhaust matter to flow out of the machine 100.

As illustrated in FIG. 1, the machine 100 may include a frame 104, one or more traction units 106 for propelling the machine 100, a body 108 supported on the frame 104, a drill system 110 (partially shown) coupled to a front end 112 of the frame 104, and an operator station 114 for accommodating an operator. The traction units 106 may be ground engaging members that are in contact with a ground surface 116 for enabling movement of the machine 100 on the ground surface 116.

The machine 100 may include a compressor (not shown) and an engine (not shown) enclosed in an engine compartment (not shown) to provide driving power to the machine 100. In an example, the engine may produce a mechanical power output or an electrical power output that may further be converted to a hydraulic power for moving the drill system 110.

The machine 100 may further include a first pre-cleaner 120 for the engine, a second pre-cleaner 122 for the compressor, and the dust ejector and exhaust tube assembly 102 for receiving engine exhaust from the engine and dust particles from the first pre-cleaner 120 and the second pre-cleaner 122. In the present embodiment, the engine and the compressor are the air-intake components in the machine 100 and therefore, are provided with the first pre-cleaner 120 and the second pre-cleaner 122. In other embodiments, the machine 100 may include other air-intake components, without departing from the scope of the present disclosure.

In one embodiment, the first pre-cleaner 120 and the second pre-cleaner 122 may be disposed upstream of the engine and the compressor, respectively. The first pre-cleaner 120 and the second pre-cleaner 122 may remove the dust particles from the air entering the engine and the compressor, respectively. Although the present disclosure is explained with regard to the first pre-cleaner 120 and the second pre-cleaner 122, the present disclosure is equally applicable to embodiments where the machine 100 may include more or fewer than two pre-cleaners and air-intake components.

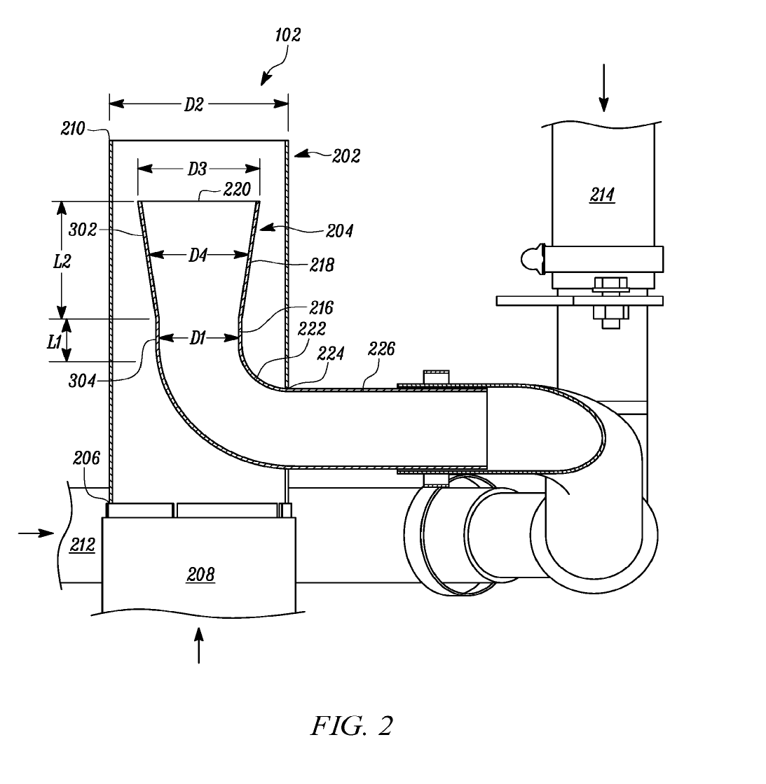

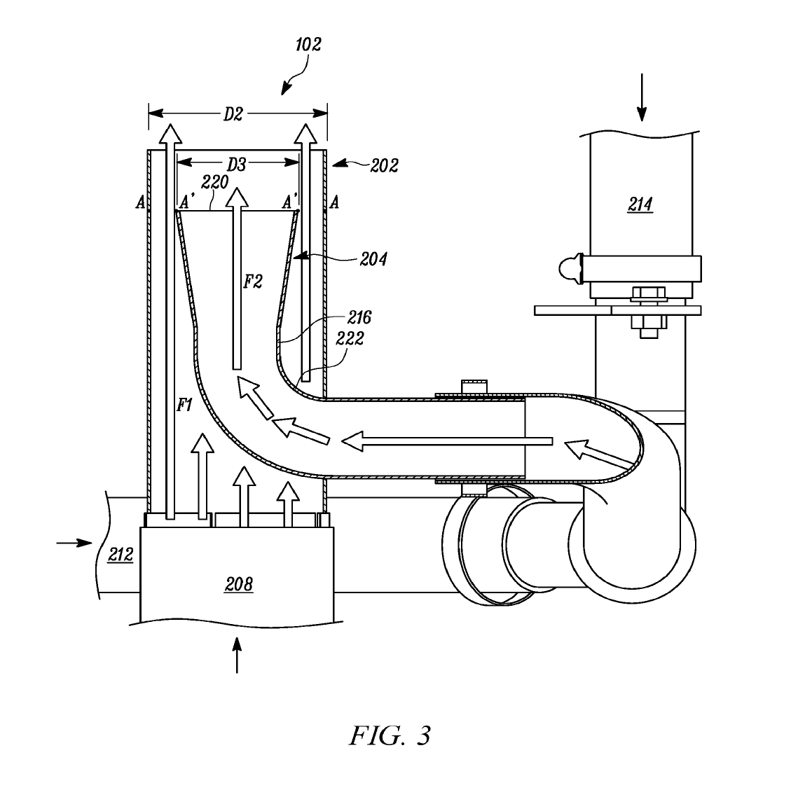

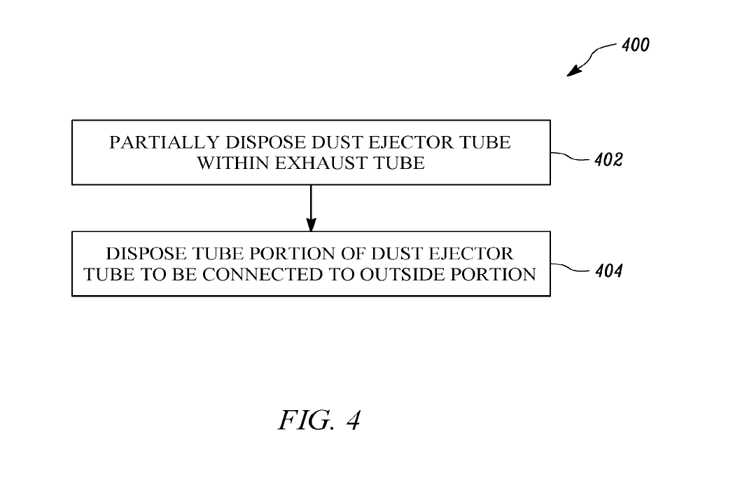

Further, the dust particles captured by the first pre-cleaner 120 and the second pre-cleaner 122 may be forwarded to the dust ejector and exhaust tube assembly 102. In one example, the dust particles may be ejected through the dust ejector and exhaust tube assembly 102. The structural and operational features of the dust ejector and exhaust tube assembly 102 are explained in detail in the description of FIG. 2, FIG. 3, and FIG. 4.

FIG. 2 illustrates a cross-sectional view of the dust ejector and exhaust tube assembly 102, according to one or more embodiments of the present disclosure. In one embodiment, the dust ejector and exhaust tube assembly 102 includes an exhaust tube 202 and a dust ejector tube 204 partially located within the exhaust tube 202. In one example, the dust ejector tube 204 may also be referred to as “dust ejector 204.” The exhaust tube 202 includes a first end 206 coupled to the engine through a first connecting conduit 208, and a second end 210 acting as an outlet for the engine exhaust and the dust particles to flow out of the machine 100. Further, the dust ejector tube 204 is coupled to the first pre-cleaner 120 and the second pre-cleaner 122 through a second connecting conduit 212 and a third connecting conduit 214 for receiving the dust particles removed from the air entering the engine and the compressor, respectively.

Further, the dust ejector tube 204 is concentrically located within the exhaust tube 202. The dust ejector tube 204 includes a tube portion 216 and an outlet portion 218 coupled to the tube portion 216. In one embodiment, the tube portion 216 has a constant diameter “D1”. The diameter “D1” is constant along a length “L1” of the tube portion 216. The constant diameter “D1” of the tube portion 216 is smaller than a diameter “D2” of the exhaust tube 202.

Further, the outlet portion 218 includes an outlet 220 of the dust ejector tube 204. At the outlet 220, dust particles leave the dust ejector tube 204, and enter into the exhaust tube 202. The outlet 220 of the dust ejector tube 204 has a diameter “D3” larger than the constant diameter “D1” of the tube portion 216.

In one embodiment, the dust ejector tube 204 also includes a bend portion 222. The bend portion 222 is a portion of the dust ejector tube 204 having a curved profile. The bend portion 222 is formed in the dust ejector tube 204 in such a manner that the tube portion 216 may be disposed between the bend portion 222 and the outlet portion 218 of the dust ejector tube 204.

In the illustrated embodiment, the diameter “D2” of the exhaust tube 202 is about 5 inches, and the constant diameter “D1” of the tube portion 216 of the dust ejector tube 204 is about 2 inches. In one embodiment, the diameter “D2” of the exhaust tube 202 is greater than or equal to 4 inches, and smaller than or equal to 5 inches. In one embodiment, the length “L1” of the tube portion 216 may be about 30 millimeters (mm). In one embodiment, a length “L2” of the outlet portion 218 may be about 103 mm.

In one embodiment, the outlet portion 218 has a diverging conical shape, also referred to as “conical shape.” The conical shape of the outlet portion 218 of the dust ejector tube 204 is illustrated in FIG. 2. As illustrated, a diameter “D4” of the outlet portion 218 increases linearly from the constant diameter “D1” of the tube portion 216 towards the diameter “D3” of the outlet 220. Therefore, in the illustrated embodiment, the diameter “D4” of the outlet portion 218 varies in a linear manner along the length “L2”. In other words, the diameter “D4” of the outlet portion 218 may be represented by a straight line on a graph with respect to the length “L2, in the illustrated embodiment.

In one embodiment, the outlet portion 218 of the dust ejector tube 204 forms a frustum. A lateral surface 302 of the outlet portion 218 is inclined at about 7 degrees with respect to a lateral surface 304 of the tube portion 216 to form the frustum. In the illustrated embodiment, the diameter “D3” of the outlet 220 of the dust ejector tube 204 is greater than or equal to 2.7 inches, and smaller than or equal to 3 inches.

Referring to FIG. 2, the exhaust tube 202 includes a wall opening 224, and the dust ejector tube 204 enters the exhaust tube 202 through the wall opening 224. In such an embodiment, the bend portion 222, the tube portion 216, and the outlet portion 218 of the dust ejector tube 204 are located within the exhaust tube 202. A portion of the dust ejector tube 204 which located outside the exhaust tube 202 is referred to as an outside portion 226 of the dust ejector tube 204. The outside portion 226 is connected to the tube portion 216 through the wall opening 224 in the exhaust tube 202. The outside portion 226 is also connected to the second connecting conduit 212 and the third connecting conduit 214 outside of the exhaust tube 202.

FIG. 3 illustrates a cross-sectional view of the dust ejector and exhaust tube assembly 102 depicting a flow path “F1” of the engine exhaust and a flow path “F2” of the dust particles from the first pre-cleaner 120 and the second pre-cleaner 122, according to one or more embodiments of the present disclosure. As shown, the exhaust tube 202 receives engine exhaust from the engine through the first connecting conduit 208. The engine exhaust follows the flow path “F1” through the exhaust tube 202 and around a portion of the dust ejector tube 204 located within the exhaust tube 202. For example, the engine exhaust flows around the bend portion 222, the tube portion 216, and the outlet portion 218 of the dust ejector tube 204. The engine exhaust flows past the outlet 220 of the dust ejector tube 204 through a small cross-sectional area AA′ created between the diameter of the dust ejector tube 204, i.e., the diameter “D3” of the outlet 220, and the diameter “D2” of the exhaust tube 202. To create the small cross-sectional area AA′, the difference between the diameter “D2” of the exhaust tube 202 and the diameter “D3” of the outlet 220 may be about 25%-35% of the diameter “D2” of the exhaust tube 202. Because the size of the cross-sectional area AA′ directly affects suction performance at the outlet 220, an appropriate size of the cross-sectional area AA′ may be selected to accommodate the expected dust flow from the dust ejector tube 204.

Further, the dust ejector tube 204 receives dust particles from the first pre-cleaner 120 and the second pre-cleaner 122 through the second connecting conduit 212 and the third connecting conduit 214, respectively. The dust particles flowing from the first pre-cleaner 120 and the second pre-cleaner 122 follow the flow path “F2” to move through the outlet 220 of the dust ejector tube 204 into the exhaust tube 202. The dust particles may get mixed with the engine exhaust in the exhaust tube 202 before flowing out of the machine 100.

FIG. 4 illustrates a flowchart for the method 600 of assembling the dust ejector and exhaust tube assembly 102, according to one or more embodiments of the present disclosure. For the sake of brevity, the aspects of the present disclosure which are already explained in detail in the description of FIG. 1, FIG. 2, and FIG. 3 are not explained in detail with regard to the description of the method 600.

At step 602, the method 600 includes partially disposing the dust ejector tube 204 within the exhaust tube 202 having the wall opening 224. The outside portion 226 of the dust ejector tube 204 is located outside the exhaust tube 202. Further, the tube portion 216 and the outlet portion 218 of the dust ejector tube 204 are located within the exhaust tube 202. In one embodiment, the bend portion 222 of the dust ejector tube 204 may also be located within the exhaust tube 202.

At step 604, the method 600 may include disposing the tube portion 216 of the dust ejector tube 204 to be connected to the outside portion 226. In one embodiment, the tube portion 216 may be connected to the outside portion 226 through the wall opening 224 in the exhaust tube 202.

In one embodiment, the tube portion 216 of the dust ejector tube 204 may have the diameter “D1” which is constant along the length “L1”. The constant diameter “D1” of the dust ejector tube 204 is smaller than the diameter “D2” of the exhaust tube 202. In another embodiment, the outlet portion 218 of the dust ejector tube 204 includes the outlet 220 of the dust ejector tube 204. The outlet 220 of the dust ejector tube 204 has the diameter “D3” which is larger than the constant diameter “D1” of the tube portion 216.

### INDUSTRIAL APPLICABILITY

The present disclosure relates to the dust ejector and exhaust tube assembly 102 and a method 600 for assembling the dust ejector and exhaust tube assembly 102. The dust ejector and exhaust tube assembly 102 may include the exhaust tube 202 and the dust ejector tube 204 located within the exhaust tube 202. The dust ejector tube 204 may include the tube portion 216 having the constant diameter “D1” smaller than the diameter “D2” of the exhaust tube 202. The dust ejector tube 204 may further include the outlet portion 218 having the outlet 220 of the dust ejector tube 204. The diameter “D3” of the outlet 220 may be larger than the constant diameter “D1” of the tube portion 216.

Although the present disclosure is explained with regard to the dust ejector and exhaust tube assembly 102 employed in the drilling machine 100, the scope of the present disclosure is not limited to the drilling machine 100. The dust ejector and exhaust tube assembly 102 of the present disclosure may be employed in any machine 100 having air-intake components, without departing from the scope of the disclosure.

In one embodiment for installing the dust ejector and exhaust tube assembly 102 in the machine 100, a conventional dust ejector and exhaust tube assembly may be replaced with the dust ejector and exhaust tube assembly 102 of the present disclosure. In another embodiment, an outlet section of a dust ejector tube of a conventional dust ejector and exhaust tube assembly may be replaced with the outlet portion 218 of the dust ejector tube 204 of the present disclosure, without departing from the scope of the present disclosure.

The dust ejector and exhaust tube assembly 102 and the method 600 of the present disclosure may offer increased suction performance for handling the dust particles received from one or more pre-cleaners, such as the first pre-cleaner 120 and the second pre-cleaner 122. The diverging conical shape of the outlet portion 218 of the dust ejector tube 204 results in creation of the small cross-sectional area AA′ between the diameter of the dust ejector tube 204, i.e., the diameter “D3” of the outlet 220, and the diameter “D2” of the exhaust tube 202. The small cross-sectional area AA′ may lead to development of a low pressure region by the flow of the engine exhaust near the outlet 220 creating a throttling effect. The throttling effect in turn increases the suction at the outlet 220 of the dust ejector tube 204.

Simultaneously, an increase in the diameter of the dust ejector tube 204, i.e., from the constant diameter “D1” to the diameter “D3” of the outlet 220, due to the conical shape of the outlet portion 218, may result in reduction of backpressure on the engine through the exhaust tube 202.

In particular, the diverging conical shape of the outlet portion 218 of the dust ejector tube 204 allows the outlet 220 to have the diameter “D3” that is larger than the diameters “D1” and “D4” of other portions of the dust ejector tube 204. This may decrease in the backpressure applied to the engine by decreasing the overall profile of the dust ejector tube 204 within the exhaust tube 202. For example, an inclination of about 7 degrees of the lateral surface 302 of the outlet portion 218 with respect to the lateral surface 304 of the tube portion 216 allows for the gradual increase in the diameter of the outlet portion 218 such that the backpressure on the engine is kept low while suction is improved.

For example, the dust ejector and exhaust tube assembly 102 provides a lower engine backpressure as compared to a conventional dust ejector and exhaust tube assembly having a dust ejector tube with an outlet section having a constant diameter.

Therefore, suction performance of the dust ejector and exhaust tube assembly 102 is improved such that the dust particles flowing from the first pre-cleaner 120 and the second pre-cleaner 122 can be efficiently ejected from the dust ejector tube 204. In one example, the suction performance of the dust ejector tube 204 with the diverging conical shape may be increased by at least two-fold as compared to the suction performance of a dust ejector tube without the diverging conical shape.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A dust ejector and exhaust tube assembly comprising:
an exhaust tube; and
a dust ejector tube at least partially located within the exhaust tube and including:
a tube portion disposed concentrically within the exhaust tube and having a constant diameter smaller than a diameter of the exhaust tube; and
an outlet portion including an outlet of the dust ejector tube, the outlet of the dust ejector tube having a diameter larger than the constant diameter of the tube portion.

2. The dust ejector and exhaust tube assembly of claim 1, wherein the diameter of the exhaust tube is greater than the diameter of the outlet of the dust ejector tube by 25%-35% of the diameter of the exhaust tube.

3. The dust ejector and exhaust tube assembly of claim 1, wherein the outlet portion is disposed concentrically within the exhaust tube.

4. The dust ejector and exhaust tube assembly of claim 1, wherein a length of the tube portion measured along a central axis of the tube portion is shorter than a length of the outlet portion measured along a central axis of the outlet portion.

5. The dust ejector and exhaust tube assembly of claim 1, wherein
the outlet portion is connected directly to the tube portion, and
the diameter of the outlet portion increases linearly from the tube portion to the outlet as a function of distance from the tube portion.

6. The dust ejector and exhaust tube assembly of claim 1, wherein
the dust ejector tube includes a bend portion, and
the tube portion is disposed between the bend portion and the outlet portion of the dust ejector tube.

7. The dust ejector and exhaust tube assembly of claim 5, wherein the outlet portion forms a frustum and a lateral surface of the outlet portion is inclined 7 degrees with respect to a lateral surface of the tube portion.

8. The dust ejector and exhaust tube assembly of claim 1, wherein the outlet portion is conically shaped.

9. The dust ejector and exhaust tube assembly of claim 1, wherein a length of the outlet portion is 103 mm.

10. A dust ejector and exhaust tube assembly comprising:
an exhaust tube having a wall opening; and
a dust ejector tube at least partially located within the exhaust tube and including:
an outside portion located outside the exhaust tube;
a tube portion having a constant diameter smaller than a diameter of the exhaust tube; and
an outlet portion connected to the tube portion and including an outlet of the dust ejector tube, a diameter of the outlet portion increasing linearly from a point closest to the tube portion to the outlet, wherein
the tube portion is connected to the outside portion via the wall opening in the exhaust tube,
engine exhaust flows through the exhaust tube and around a portion of the dust ejector tube located within the exhaust tube, and
dust particles flow through the outlet of the dust ejector tube into the exhaust tube.

11. The dust ejector and exhaust tube assembly of claim 10, wherein the diameter of the exhaust tube is greater than the diameter of the outlet of the dust ejector tube by 25%-35% of the diameter of the exhaust tube.

12. The dust ejector and exhaust tube assembly of claim 10, wherein the dust ejector tube is disposed concentrically within the exhaust tube.

13. The dust ejector and exhaust tube assembly of claim 10, wherein a length of the tube portion measured along a central axis of the tube portion is shorter than a length of the outlet portion measured along a central axis of the outlet portion.

14. The dust ejector and exhaust tube assembly of claim 10, wherein the tube portion is disposed concentrically within the exhaust tube and a diameter of the outlet of the dust ejector tube is larger than the constant diameter of the tube portion.

15. The dust ejector and exhaust tube assembly of claim 10, wherein
the dust ejector tube includes a bend portion, and
the tube portion is disposed between the bend portion and the outlet portion of the dust ejector tube.

16. The dust ejector and exhaust tube assembly of claim 10, wherein the outlet portion forms a frustum and a lateral surface of the outlet portion is inclined 7 degrees with respect to a lateral surface of the tube portion.

17. The dust ejector and exhaust tube assembly of claim 10, wherein the outlet portion is conically shaped.

18. The dust ejector and exhaust tube assembly of claim 10, wherein a length of the outlet portion is 103 mm.

19. A method of assembling a dust ejector and exhaust tube assembly comprising:
partially disposing a dust ejector tube within an exhaust tube having a wall opening, wherein an outside portion of the dust ejector tube is located outside the exhaust tube, and a tube portion of the dust ejector tube and an outlet portion of the dust ejector tube are located within the exhaust tube; and
disposing the tube portion of the dust ejector tube to be connected to the outside portion via the wall opening in the exhaust tube, wherein
the tube portion of the dust ejector tube has a constant diameter smaller than a diameter of the exhaust tube, and
the outlet portion of the dust ejector tube includes an outlet of the dust ejector tube, the outlet of the dust ejector tube having a diameter larger than a diameter of any other part of the outlet portion.
